(19) United States
(12) Patent Application Publication
(10) Pub. No.: US 2011/0093589 A1
(43) Pub. Date: Apr. 21, 2011

(54) DETERMINING USAGE OF COMPUTING DEVICES THAT STORE STATE INFORMATION ON HOST COMPUTER SYSTEMS

(75) Inventors: Gregory Dale, Leesburg, VA (US); Yonathan Nuta, Arlington, VA (US)

(73) Assignee: COMSCORE, INC., Reston, VA (US)

(21) Appl. No.: 12/883,505

(22) Filed: Sep. 16, 2010

Related U.S. Application Data
(60) Provisional application No. 61/242,925, filed on Sep. 16, 2009.

(51) Int. Cl. G06F 15/173

(52) U.S. Cl. 709/224

(57) ABSTRACT

A state storage application can be configured to retrieve, from a computing device coupled to a host computing system, state information for the computing device, with the state information reflecting a current or past state of the computing device. The state storage application can be further configured to store the retrieved state information in a storage medium. A monitoring application can be configured to access the stored state information, and send at least a portion of the accessed state information to one or more servers.

### CROSS REFERENCE TO RELATED APPLICATION

This application claims the benefit of U.S. Provisional Application No. 61/242,925, filed Sep. 16, 2009, and titled “Determining Usage of Computing Devices that Store State Information on Host Computer Systems”, the disclosure of which is considered part of (and is incorporated by reference in) the disclosure of this application.

### BACKGROUND

Internet audience measurement may be useful for a number of reasons. For example, some organizations may want to be able to make claims about the size and growth of their audiences or technologies. In addition, understanding Internet audience visitation and habits may be useful in supporting advertising planning, buying, and selling. Furthermore, measurement of Internet access and other usage by users of particular types of computing devices may be particularly useful.

### SUMMARY

In one general aspect, a host computing system includes one or more processing devices and a storage medium storing instructions that, when executed by the one or more processing devices, cause the one or more processing devices to implement a state storage application and a monitoring application. The state storage application is configured to retrieve, from a computing device coupled to the host computing system, state information for the computing device, the state information reflecting a current or past state of the computing device. The state storage application is further configured to store the retrieved state information in the storage medium. The monitoring application is configured to access the stored state information, and send at least a portion of the accessed state information to one or more servers.

Implementations may include one or more of the following features. For example, to send at least a portion of the accessed state information to the one or more servers, the monitoring application may be configured to extract usage information from the accessed state information, the extracted usage information reflecting information about a user's usage of the computing device, and send the extracted usage information to the one or more servers.

The state information may be stored as multiple files. To extract usage information from the accessed state information, the monitoring application may be configured to select a subset of the multiple files, and send the selected subset of files to the one or more servers. To select a subset of the multiple files, the monitoring application may be configured to select the subset of the multiple files based on rules designating the subset of the multiple files.

The usage information may include identifiers of web pages accessed by the computing device over a network. To send the extracted usage information to the server, the monitoring application may simulate a request for the web pages, record information regarding the request and subsequent response, and send the recorded information to the one or more servers.

The system may further include a browser application configured to send requests for resources and receive responses to the sent requests. The monitoring application may be configured to record information regarding the requests sent by the browser and subsequent responses, and send the recorded information regarding the requests sent by the browser and subsequent responses to the server.

The one or more servers may be configured to generate reports reflecting usage of the host computing system or usage of the computing device based on the information sent to the one or more servers. The reports may relate to the number of unique visitors visiting certain web pages or groups of web pages using computing devices, unique visitors within a particular demographic visiting certain web pages or groups of web pages using computing devices. The reports may relate to the amount of times a particular application or program is used on computing devices, the amount of responses to SMS or MMS advertising messages sent to computing devices, the number of applications installed on computing devices, the installation rate of a given application or of applications in aggregate on computing devices, the most popular applications on computing devices, installation locations for applications on computing devices, comparisons of various types of usage of computing devices, or website visitation rates between host computing systems and computing devices. The reports may relate to related activities across the computing devices and host computing systems. The reports may relate to a comparison of consumption of a particular service across host computing systems and computing devices. The reports may relate to a comparison of web search usage on computing devices versus web search usage on host computing systems, or a comparison of the amount of data accessed on host computing systems versus the amount of data accessed on computing devices.

The host computing system may be a desktop computer and the computing device may be a mobile device. The state information may be a backup of the computing device. The state information may include settings and user preferences related to the computing device, data for one or more applications that run on the computing device, or records of one or more actions performed by the computing device.

The state information may include information about resources accessed by the computing device over a network, phone calls made using the computing device SMS messages sent by the computing device, applications running on the computing device, settings of the computing device, networks to which the computing device has been connected, search queries submitted for web pages, Bluetooth devices that have been paired with the computing device, WiFi networks to which the computing device has been connected, the amount of and destination of messages, applications installed, applications purchased, Global Positioning System (GPS) coordinates reflecting locations of the computing device, location information for weather services, addresses for location-based services, layout of buttons on a graphical user interface (GUI) of the computing device, applications allowed to use GPS coordinates, e-mail settings, calendar settings, preferred WiFi networks, whether WiFi or Bluetooth is enabled, contact lists, time zone preferences, stocks to be tracked, speed dial list, volume settings, or other various system and application settings.

In another general aspect, a system includes one or more computing devices configured to send state information to a host computing system. The state information reflects a current or past state of the computing device. The system further includes one or more host computing systems configured to receive the state information from the one or more computing devices. The one or more host computing systems is further configured to store the received state information. The one or more host computing systems are further configured to send at least a portion of the stored state information to one or more servers. The system includes one or more servers configured to receive at least a portion of the stored state information from the one or more host computing systems and generate one or more reports reflecting usage of the one or more computing devices based on the received state information.

Implementations may include one or more of the following features. For example, to send at least a portion of the stored state information to the one or more servers, the one or more host computing systems may be configured to access the stored state information, extract usage information from the accessed state information, and send the extracted usage information to the one or more servers. The extracted usage information may reflect information about a user's usage of the one or more computing devices.

The state information may be stored as multiple files. To extract usage information from the accessed state information, the one or more host computing systems are configured to select a subset of the multiple files and send the selected subset of files to the one or more servers. To select a subset of the multiple files, the one or more host computing systems may be configured to select the subset of the multiple files based on rules designating the subset of the multiple files.

The usage information may include identifiers of web pages accessed by the computing device over a network. To send the extracted usage information to the server, the one or more host computing systems may include a monitoring application that is configured to simulate a request for the web pages, record information regarding the request and subsequent response, and send the recorded information to the one or more servers.

The one or more host computing systems may be configured to implement a browser application that is configured to send requests for resources and receive responses to the sent requests, record information regarding the requests sent by the browser and subsequent responses, and send the recorded information regarding the requests sent by the browser and subsequent responses to the server.

The one or more host computing systems may be a desktop computer and the one or more computing devices may be a mobile device. The state information may be a backup of the one or more computing devices. The state information may include settings and user preferences related to the computing device, data for one or more applications that run on the computing device, or records of one or more actions performed by the computing device.

The state information may include information about resources accessed by the one or more computing devices over a network, information about phone calls made using the one or more computing devices, SMS messages sent by the one or more computing devices, applications running on the one or more computing devices, settings of the one or more computing devices, networks to which the one or more computing devices has been connected, search queries submitted for web pages, Bluetooth devices that have been paired with the one or more computing devices, WiFi networks to which the one or more computing devices has been connected, the amount of and destination of messages, applications installed, applications purchased, Global Positioning System (GPS) coordinates reflecting locations of the one or more computing devices, location information for weather services, addresses for location-based services, layout of buttons on a graphical user interface (GUI) of the one or more computing devices, applications allowed to use GPS coordinates, e-mail settings, calendar settings, preferred WiFi networks, whether WiFi or Bluetooth is enabled, contact lists, time zone preferences, stocks to be tracked, speed dial list, volume settings, or other various system and application settings.

The reports may relate to the number of unique visitors visiting certain web pages or groups of web pages using computing devices, unique visitors within a particular demographic visiting certain web pages or groups of web pages using computing devices. The reports may relate to the amount of times a particular application or program is used on computing devices, the amount of responses to SMS or MMS advertising messages sent to computing devices, the number of applications installed on computing devices, the installation rate of a given application or of applications in aggregate on computing devices, the most popular applications on computing devices, installation locations for applications on computing devices, comparisons of various types of usage of computing devices, or website visitation rates between host computing systems and computing devices. The reports may relate to related activities across the computing devices and host computing systems. The reports may relate to a comparison of consumption of a particular service across host computing systems and computing devices. The reports may relate to a comparison of web search usage on computing devices versus web search usage on host computing systems or a comparison of the amount of data accessed on host computing systems versus the amount of data accessed on computing devices.

In another general aspect, a method includes retrieving, from a computing device coupled to a host computing system, state information for the computing device. The state information reflects a current or past state of the computing device. The method further includes storing the retrieved state information on the host computing system. The method further includes accessing the stored state information and sending at least a portion of the accessed state information to one or more servers.

Implementations may include one or more of the following features. For example, sending at least a portion of the accessed state information to the one or more servers may include extracting usage information from the accessed state information, and sending the extracted usage information to the one or more servers. The extracted usage information may reflect information about a user's usage of the computing device.

The state information may be stored as multiple files. Extracting usage information from the accessed state information may include selecting a subset of the multiple files, and sending the selected subset of files to the one or more servers. Selecting a subset of the multiple files may include selecting the subset of the multiple files based on rules designating the subset of the multiple files.

The usage information may include identifiers of web pages accessed by the computing device over a network. Sending the extracted usage information to the server may include simulating a request for the web pages, records information regarding the request and subsequent response, and sending the recorded information to the one or more servers.

A browser application may be configured on the host computing device to send requests for resources and receive responses to the sent requests. The method may further include recording information regarding the requests sent by the browser and subsequent responses, and sending the recorded information regarding the requests sent by the browser and subsequent responses to the server.

The method may further include generating reports reflecting usage of the host computing system or usage of the computing device based on the information sent to the one or more servers. The reports may relate to the number of unique visitors visiting certain web pages or groups of web pages using computing devices, unique visitors within a particular demographic visiting certain web pages or groups of web pages using computing devices. The reports may relate to the amount of times a particular application or program is used on computing devices, the amount of responses to SMS or MMS advertising messages sent to computing devices, the number of applications installed on computing devices, the installation rate of a given application or of applications in aggregate on computing devices, the most popular applications on computing devices, installation locations for applications on computing devices, comparisons of various types of usage of computing devices, or website visitation rates between host computing systems and computing devices. The reports may relate to related activities across the computing devices and host computing systems. The reports may relate to a comparison of consumption of a particular service across host computing systems and computing devices. The reports may relate to a comparison of web search usage on computing devices versus web search usage on host computing systems, or a comparison of the amount of data accessed on host computing systems versus the amount of data accessed on computing devices.

The host computing system may be a desktop computer and the computing device may be a mobile device. The state information may be a backup of the computing device. The state information may include settings and user preferences related to the computing device, data for one or more applications that run on the computing device, or records of one or more actions performed by the computing device.

The state information may include information about resources accessed by the computing device over a network, phone calls made using the computing device SMS messages sent by the computing device, applications running on the computing device, settings of the computing device, networks to which the computing device has been connected, search queries submitted for web pages, Bluetooth devices that have been paired with the computing device, WiFi networks to which the computing device has been connected, the amount of and destination of messages, applications installed, applications purchased, Global Positioning System (GPS) coordinates reflecting locations of the computing device, location information for weather services, addresses for location-based services, layout of buttons on a graphical user interface (GUI) of the computing device, applications allowed to use GPS coordinates, e-mail settings, calendar settings, preferred WiFi networks, whether WiFi or Bluetooth is enabled, contact lists, time zone preferences, stocks to be tracked, speed dial list, volume settings, or other various system and application settings.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1 illustrates an example of a system in which a panel of users may be used to determine analytics related to how users use computing devices that can be coupled to host computing systems.

FIG. 2 illustrates an example of a system that provides for the collection of state information for a computing device stored on a host computing system.

FIG. 3 is a flowchart illustrating a process that may be performed to collect usage information about a computing device that stores state information on a host computing system.

FIG. 4 illustrates an example of a reporting server.

FIG. 5 is a flow chart illustrating an example of a process that may be performed to generate usage reports.

FIG. 6 illustrates an example of a state information file.

FIG. 7 illustrates an excerpt 700 of an example of an XML file that contains information about HTTP traffic.

### DETAILED DESCRIPTION

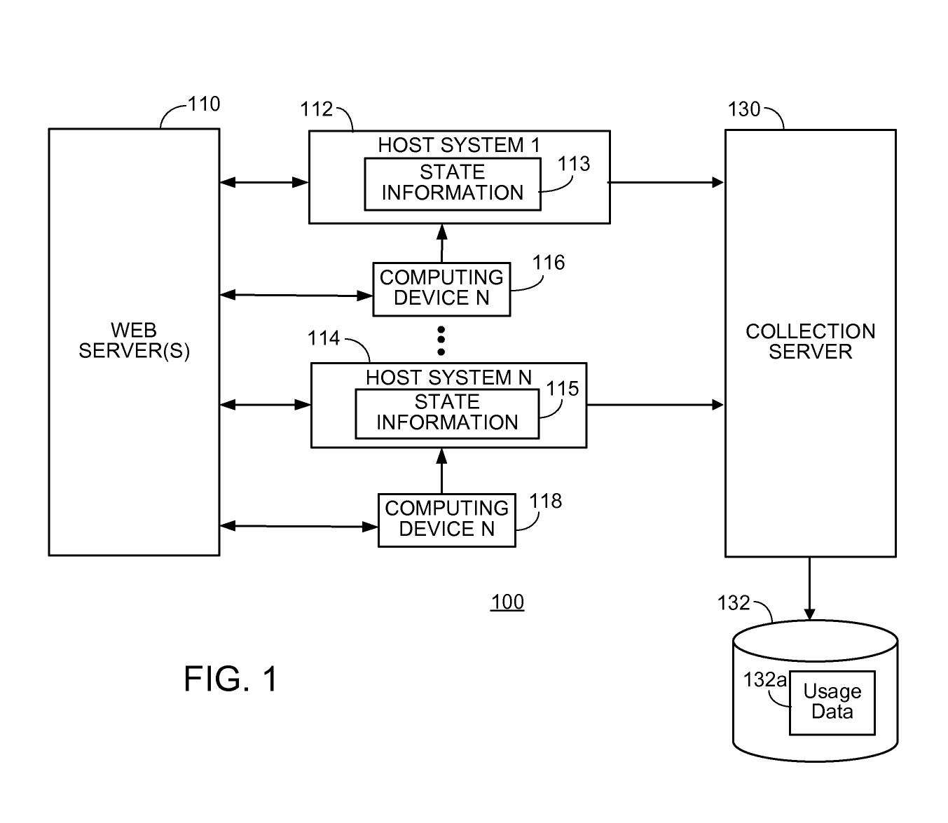

FIG. 1 illustrates an example of a system 100 in which a panel of users may be used to determine analytics related to how users use computing devices 116, 118 that can be coupled to host computing systems 112, 114. The system 100 includes the host computing systems 112, 114, the computing devices 116, 118, one or more web servers 110, one or more collection servers 130, and a storage 132.

Generally, each of the host computing systems 112, 114, computing devices 116, 118, the collection server 130, and the web servers 110 may be implemented using, for example, a general-purpose computer capable of responding to and executing instructions in a defined manner, a personal computer, a special-purpose computer, a workstation, a server, or a mobile device (e.g., a mobile phone). Host computing systems 112, 114, computing devices 116, 118, collection server 130, and web servers 110 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by a host computing system 112, 114, computing system 116, 118, collection server 130, and web servers 110.

The computing devices 116, 118 are configured to send state information to the respective host computing systems 112, 114, which stores this state information. The state information may be communicated to the host computing system 112, 114 when the computing device 116, 118 is connected to the host computing system 112, 114 so as to create a backup for the computing device 116, 118.

The state information generally reflects a current or past state of the computing device 116, 118. For example, the state information may include settings and user preferences related to the computing device 116, 118, data for one or more applications that run on the computing device 116, 118, or records of one or more actions performed by the computing device 116, 118. In particular, for example, the state information may include information such as a history of web pages visited using a web browser on the computing device 116, 118, a list of applications installed on the computing device 116, 118, message history (e.g., e-mail, short message service (SMS), or multimedia message service (MMS)), contact lists, time zone preferences, stocks to be tracked, applications purchased, stored addresses for location-based services, paired Bluetooth devices, calendar settings, location information for weather services, speed dial list, volume settings, and other various system and application settings.

Accordingly, the users in the panel may employ computing devices 116, 118 to access resources on the Internet, such as webpages located at the web servers 110, as well as perform other actions. Information about the resource accesses and other actions are stored on the computing devices 116, 118, for example, as part of the normal operation of the computing devices 116, 118. Such information may be transferred to host computing systems 112, 114 and stored as state information. As a result, the stored state information may reflect web page or other accesses, as well as other uses of the computing device 114, 116. The host computing systems 112, 114 access this information to obtain and send to a collection server 130 information related to the resource accesses and other actions performed using the computing devices 116, 118. As described further below, this information may be used to derive analytics about how users use the computing devices 116, 118 in general and/or how the computing devices 116, 118 are used to access resources on, e.g., the Internet.

In general, the users of the host computing systems 112, 114 and computing devices 116, 118 can be a group of users that are a sample of a larger universe being measured, such as the universe of all Internet users, all Internet users in a geographic region, or all users of computing devices like computing devices 116, 118. To understand the overall behavior of the universe being measured, the behavior from this sample is projected to the universe being measured. The size of the universe being measured and/or the demographic composition of that universe may be obtained, for example, using independent measurements or studies. For example, enumeration studies may be conducted monthly (or at other intervals) using random digit dialing.

The users in the panel may be recruited by an entity controlling the collection server 130, and the entity may collect various demographic information regarding the users in the panel, such as age, sex, household size, household composition, geographic region, and household income. The techniques chosen to recruit users may be chosen or developed to help insure that a good representative sample of the universe being measured is obtained, biases in the sample are minimized, and the highest manageable cooperation rates are achieved. In some implementations, once a user is recruited, a monitoring application may be installed on the user's host computing system 112, 114 to access the state information and send to the collection server 130 information about the user's use of the computing device 116, 118 to access resources on the Internet and perform other actions.

The collection server 130 aggregates the information received from the host computing systems and stores this aggregated information in a storage 132 as usage data 132a. The usage data 132a may be analyzed to determine the webpage visitation or other habits of users in the panel, which may be extrapolated to the larger population being measured (e.g., all Internet users or all users of computing devices like computing devices 116, 118). To extrapolate the usage of the panel members to the larger universe being measured, some or all of the members of the panel are assigned a weight, which is used to project the members' activity to the larger universe. In some implementations, a subset of all of the members of the panel may be weighted and projected. For instance, analysis of the received data may indicate that the data collected from some members of the panel may be unreliable. Those members may be excluded from reporting and, hence, from being weighted and projected.

The reporting sample (those included in the weighting and projection) are weighted to insure that the reporting sample reflects the demographic composition of the universe to be measured, and this weighted sample is projected to the universe. This may be accomplished by determining a projection weight for each member of the reporting sample and applying that projection weight to the usage of that member.

The usage behavior of the weighted and projected sample is then considered a representative portrayal of the behavior of the defined universe. Behavioral patterns observed in the weighted, projected sample are assumed to reflect behavioral patterns in the universe.

Reports can be generated from this information. For example, this data may be used to estimate the number of unique visitors visiting certain web pages or groups of web pages using the computing devices, or unique visitors within a particular demographic visiting certain web pages or groups of web pages using the computing devices. For instance, in one implementation, the computing devices are Apple® iPhones® and the reports generated may reflect the number of unique visits by iPhone® users to particular websites or webpages. This data may also be used to determine other estimates, such as estimates related to the amount of times a particular application or program is used, the amount of responses to SMS or MMS advertising messages, the number of applications installed, the installation rate of a given application or of applications in aggregate, the most popular applications, installation locations for applications (e.g., ranking on the position of an icon configured to launch the application relative to the positions of icons for other applications). Other estimates may, for example, be related to comparisons of various types of usage of the computing device. For example, estimates may compare call usage (e.g., if the computing device is a mobile phone or otherwise supports phone calls) vs. e-mail usage, or text (SMS) messaging vs. native application-based e-mail usage, or native application-based e-mail usage vs. web-based e-mail usage.

In some implementations, the host computing system 112, 114 also collects information about the user's use of the host computing system 112, 114 to access resources on the Internet and perform other actions, and sends that information to the collection server 130. Further, in some implementations, additional information, such as the applications installed on the host computing system 112, 114 and how frequently the applications are used may be collected and sent to the collection server 130. In some implementations, a monitoring application that is installed on the host computing system collects and sends this information to the collection server 130. This information may be used to understand how users use the host computing systems 112, 114 in general and how the host computing systems 112, 114 are used to access the Internet.

For instance, this information about the use of host computing systems 112, 114 may additionally be aggregated and used to generate reports regarding usage of host computing systems 112, 114 using the techniques described above. Because the information about the usage of the computing device 116, 118 and the information about the usage of the corresponding host computing system 112, 114 can be correlated, for example, by using a unique identifier associated with the host computing device, comparative reports can be generated. Such reports, for instance, can compare visitation patterns using the computing devices to visitation patterns using the host computing system.

For example, reports may be generated regarding website visitation rates between the host computing system and computing device (e.g., number of users that visit a particular website on the computing device, but not on the host computing system or number of users that visit a particular website on both the host computing system and the computing device). Reports may be generated regarding related activities across the computing device and host computing system (e.g., number of users exposed to an advertisement for a certain product or brand on the computing device who then search for or visit a website related to the product or brand on the host computing system). Other comparative usage reports can be generated, such as reports that compare consumption of a particular service across the host computing system and the computing device (e.g., number of users that do not access a service, such as Facebook©, by visiting a website on the host computing, but do access the service using an application on the computing device, or vice versa, or number of users that access the service on both the host computing system and the computing device). Reports may compare other usages between the computing device and host computing system, such as comparison of web search usage on the computing device versus web search usage on the host computing system, or the amount of data accessed on the host computing system versus the amount of data accessed on the computing device.

In implementations in which information is collected about both a host computing system and a computing device, using a single monitoring application to collect information for both may have certain advantages. For instance, using a single monitoring application may increase the amount of information collected because only a single application needs to be downloaded and installed by a user. If, for example, a monitoring application needed to be installed on the host computing system and a separate monitoring application needed to be installed on the computing device, users may be less inclined to go through the effort of installing both.

In the example shown in FIG. 1, the system 100 includes host computing systems 112, 114 and computing devices 116, 118. However, in other implementations, there may be more or fewer host computing systems 112, 114 and/or computing devices 116, 118. Similarly, in the example shown in FIG. 1, there is a single collection server 130. However, in other implementations there may be more than one collection server 130. For example, each of the host computing systems 112, 114 may send data to more than one collection server for redundancy. In other implementations, the host computing systems 112, 114 may send data to different collection servers. In this implementation, the data, which represents data from the entire panel, may be communicated to and aggregated at a central location for later processing. The central location may be one of the collection servers.

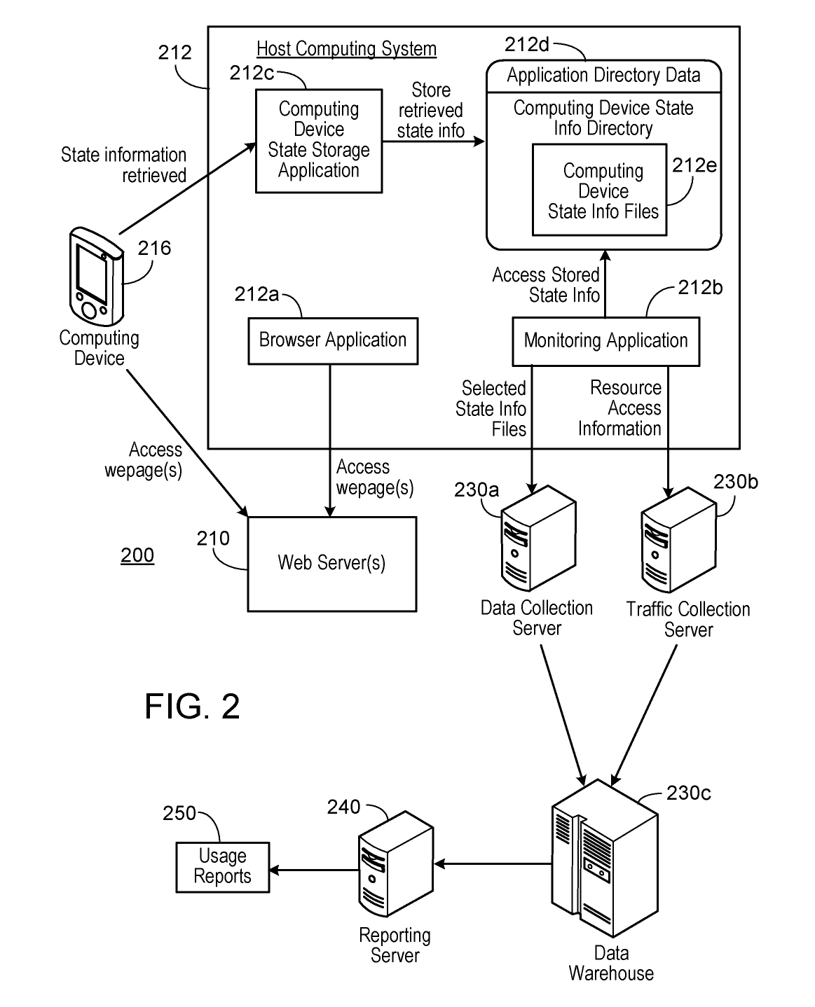

FIG. 2 illustrates an example of a system 200 that provides for the collection of state information for a computing device stored on a host computing system. The collection and analysis of this data may yield analytics regarding how users employ such computing devices.

The system 200 includes a host computing system 212, a computing device 216, web servers 210, collection servers 230a, 230b, a data warehouse 230c, and a reporting server 240. While FIG. 2 only depicts a single computing device 216 and a single host computing system 212, there may be multiple such devices that form as panel, as shown in FIG. 1.

In some implementations, the host computing systems are personal computers (e.g., a desktop or laptop computer) and the computing devices are mobile phones that store state information on the host computing systems. The mobile phones include capabilities such as e-mail, calendaring, and/or web browsing, in addition to the ability to place phone calls. The mobile phones also may support Short Message Service (SMS) and/or Multimedia Message Service (MMS), as well as the ability to run additional applications. Such devices include, for example, the Apple® iPhone® and RIM® Blackberry® devices.

In some implementations, the computing devices for which information is collected are limited to one type, brand, and/or model (e.g., only iPhone® devices). In other implementations, the devices for which information is collected include multiple types, brands, or models (e.g., iPhone® and Blackberry® devices). In implementations in which the computing devices include multiple types, brands, or models, the reports generated based on the information may be segmenting according to the type, brand, or model, and/or the reports may include an aggregate of the devices.

The host computing system 212 is capable of communicating with the web server 210 and the collection servers 230a, 230b over a network such as, for example, the Internet. Similarly, the computing device 216 can communicate with the web server 210 over a network, such as the Internet (or, for example, a combination of a cellular, or other, network and the Internet). The computing device 216 can also communicate with the host computing system 212. In some implementations, the computing device 216 communicates with the host computing system using a local connection, such as Universal Serial Bus (USB), Bluetooth, WiFi or other wired or wireless connection. In other implementations, the computing device may, alternatively or additionally, communicate with the host computing system 212 through a remote connection, such as the Internet.

A user may use, for example, a browser application on the computing device 216 to retrieve resources, such as webpages, from the web server 210 using, for example, HTTP. Which webpages are accessed may be stored as a series of uniform resource locators (URLs) in the browser history on the computing device 216. The computing device 216 may store other information as a user uses the computing device, such as search queries submitted for web pages, Bluetooth devices that have been paired with the computing device 216, WiFi networks to which the computing device 216 has been connected, phone numbers called, the amount of and destination of messages such as SMS, MMS, or e-mail, applications installed, applications purchased, Global Positioning System (GPS) coordinates reflecting locations of the computing device 216, location information for weather services, and/or addresses for location-based services (e.g., mapping or navigation applications). In addition, the computing device 216 may store user preferences or settings such as the layout of buttons on a graphical user interface (GUI) of the computing device 216, applications allowed to use GPS coordinates, e-mail settings, calendar settings, preferred WiFi networks, whether WiFi or Bluetooth is enabled, contact lists, time zone preferences, stocks to be tracked, speed dial list, volume settings, or other various system and application settings. This various information may be stored by the computing device 216 during the normal operation of the computing device.

When the computing device 216 is connected to the host computing system 212, such information may be transferred to and stored on the host computing system 212 as a backup. Such a backup can, for instance, be used to restore the computing device 216 to a previous state, which may be desirable if there is an error in the operation of the computing device 216. In addition, this stored state information is accessed, and at least a portion of this information is communicated to the collection servers 230a and 230b. The communicated information is then processed (with or without data from other systems) to determine analytics regarding usage of devices such as the computing device 216.

More specifically, the client system 204 includes one or more processors and a storage medium storing instructions that, when executed by the one or more processing devices, cause the one or more processing devices to implement a browser application 212a, a monitoring application 212b, a state storage application 212c, and a state information directory 212d.

The browser application 212a is configured to request and display web pages or other resources on the host computing system 204. For instance, the browser 212a may use HTTP to request and receive network resources (e.g., web pages) that have a corresponding URL.

The state storage application 212c is configured to retrieve state information from the computing device 216 and store that retrieved state information on host computing device 212. For instance, when the computing device 216 is connected to the host computing system 212 using, for example, a local connection, the state storage application 212c detects that the computing device 216 has been connected and retrieves the state information from the computing device 216. A user of the computing device 216 may connect the computing device 216 to host computing system 212 at certain times, for example, to backup the computing device 216 on the host computing system 212 or to synchronize information stored and used on both the host computing system 212 and the computing device 216. The user may be encouraged, for example, by the entity controlling the collection servers 230a and 230b to connect the computing device 216 to the host computing system 212 on a certain schedule (e.g., at least once per month).

As described above, the state information may include, for example, information such as settings and other preferences related to the computing device 216, data for one or more applications that run on the computing device 216, or records of one or more actions performed by the computing device 216. The state information storage application 212c stores the retrieved state information in, for example, the state information directory 212d. The state information may be stored, for example, as one or more files 212e in the state information directory 212d. The files 212e may be in a flat-file or database format. For instance, the files 212e may be in an XML-based property list (plist) format or a sqlite format, or some files may be in one format while the others are in the other format.

The monitoring application 212b is configured to access the state information stored in the state information directory 212d and send at least a portion of this state information to one or both collection servers 230a and 230b. For instance, the monitoring application 212b may access the state information and send to the traffic collection server 230b information about the URLs of web pages or other resources accessed by the user using the computing device 216, the times those pages or resources were accessed, and an identifier associated with the particular host computing system on which the monitoring application is installed (which may be associated with demographic information collected regarding the user or users of that host computing system). The monitoring application 212b can also send to the data collection 230a server other information about the user's usage of the computing device 216, as reflected by the state information.

The monitoring application 212b may be an application that is downloaded to the host computing system 212 to perform the operations as described.

In some implementations, the monitoring application 212b is also configured to access the network and/or software stack of the host computing system 212. As a result, the monitoring application 212b may monitor network traffic to analyze and collect information regarding requests for resources sent from the host computing system and subsequent responses. For instance, the monitoring application may analyze and collect information regarding HTTP requests issued by the browser application 212a and subsequent HTTP responses to those requests. The monitoring application 212b then sends the collected information to the traffic collection server 230b. This collected information may include, for example, the URL requested and a time stamp of when the response was received, as well as other information such as HTTP response codes, HTTP headers, and information about the response body (e.g., an HTTP response body) and/or the request body (e.g., an HTTP request body).

The monitoring application 212b may send this information to the traffic collection server 230b as the requests and responses occur, or the monitoring application 212b may collect this information, and send the collected information to the collection server 230b on a periodic or other basis. For example, the collected information may be collected at the host computer system 212 in an eXtensible Mark-up Language (XML) file, with the XML file being transmitted to the collection server 230b on a periodic or immediate basis using an Hypertext Protocol (HTTP) POST.

The collection servers 230a and 230b are configured to receive the information sent by the monitoring application 212b. For instance, the traffic collection server 230b is configured to receive the information regarding resource accesses by the computing device 216 and/or the host computing system 212. The data collection server 230b is configured to receive other usage information regarding the computing device 216 and/or host computing system 212. The collection servers 230a and 230b are configured to process the received information such that the information can be stored in a data warehouse 230c.

The reporting server 240 is configured to access the data stored in data warehouse 230c and use the accessed information to generate usage reports 250. For example, the reporting server 240 may generate the usage reports 250 by weighting the members of a reporting sample of the panel to insure that the reporting sample reflects the demographic composition of the universe to be measured, and projecting the weighted sample to the universe to be measured (e.g., all users of devices like computing device 216). The usage behavior of the weighted and projected sample is then considered a representative portrayal of the behavior of the defined universe. Behavioral patterns observed in the weighted, projected sample are used to generate the usage reports 250, which may include some or all of the reports described above or below. For instance, this data may be used to estimate the number of unique visitors visiting certain web pages or groups of web pages using the computing devices, or unique visitors within a particular demographic visiting certain web pages or groups of web pages using the computing devices.

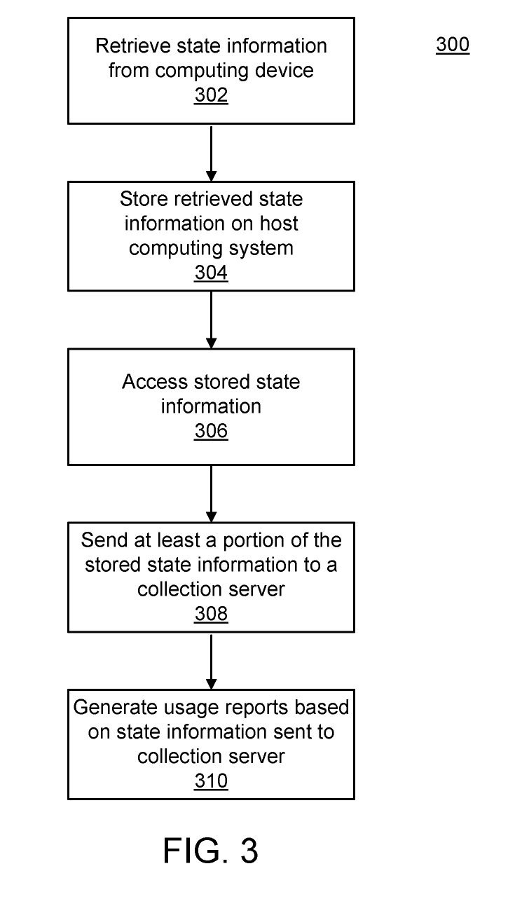

FIG. 3 is a flowchart illustrating a process 300 that may be performed to collect usage information about a computing device that stores state information on a host computing system. The following describes process 300 as being performed by components of the system of FIG. 2. However, the process 300 may be performed by other systems or system configurations.

When the computing device 216 is connected to the host computing system 212, the state storage application 212c retrieves state information from the computing device 216 (302) and stores that retrieved state information on host computing device 212 (304), e.g., in the state information directory 212d.

In general, the monitoring application 212b accesses the stored state information (306) and sends at least a portion of the stored state information to the collection servers 230a and 230b (308). For instance, the monitoring application 212b extracts usage information from the accessed state information, and sends the usage information to the collection servers 230a and 230b. In some implementations, the monitoring application 212b does so periodically (e.g., once per day).

To access the state information, the monitoring application 212b may use an Application Programming Interface (API) to determine the location of the state information directory 212d. The monitoring application 212b may then scan the directory for certain files based, for instance, on the file names to find files that contain usage information. For instance, the monitoring application 212b may access rules that define the filenames of the files that contain usage information of interest and scan the directory for the files matching the rules. If those files have a timestamp that is more recent than the previous scan, the monitoring application 212b selects those files.

To extract usage information, the monitoring application 216 may, for example, access the selected file or files that contain the identifiers (e.g., URLs) of web pages accessed using the computing device 216 and simulate an HTTP request for those web pages. In implementations where the monitoring application 212b is monitoring the network traffic, the monitoring application 212b records and sends to the traffic collection server 230b information about the request and subsequent responses from the simulation in a similar manner as a request from the browser application 212a. For instance, the monitoring application 212 may analyze and collect the URL requested and a time stamp of when the response was received, as well as other information such as HTTP response codes, HTTP headers, and information about the response body (e.g., an HTTP response body) and/or the request body (e.g., an HTTP request body). The monitoring application 212b may also identify the request and response as being the result of accessing the state information, so as to distinguish the request and response from a browser request 212a. In addition, if a timestamp of when a given webpage was accessed by the computing device 216 is included in the selected files, the monitoring application 212b may append this to the request so that the timestamp is also sent to the traffic collection server 230b.

In other implementations, the monitoring application may, alternatively or additionally, send the selected files to the traffic collection server, or extract the URLs and other information of interest (e.g., a timestamp of when the URL was accessed) from the selected files and send a list of the URLs and other information to the traffic collection server 230b.

To extract and send other usage information, the monitoring application may send the other selected files (e.g., those that contain other state information of interest, such as the state information that would support some or all of the various reports described above or below) to the data collection server 230a. For instance, the monitoring application 212b may compress the files (e.g., using gzip) and send the compressed files to the data collection server 230. The files may be sent to the data collection server 230a with an identifier associated with the host computing device 212.

The information received by the collection servers 230a and 230b can then be used to generate usage reports 250 about how users use the computing devices and/or the host computing devices (310). For instance, a process on the data collection server 230a accesses the received files, extracts the information of interest from those files, and stores this information in a data warehouse 230c. Similarly, a process on the traffic collection server 230b accesses the data received from the monitoring application 212b, extracts information regarding resource access (e.g., URL accessed, date accessed, and time accessed), and stores this information in the data warehouse 230c. For instance, the information from the data collection server 230a and the traffic collection server 230b is stored in one or more relational tables in a relational database in the data warehouse 230c. The reporting server may then use the information stored in the data warehouse 230c to generate the usage reports 250, which may include some or all of the reports described above or below.

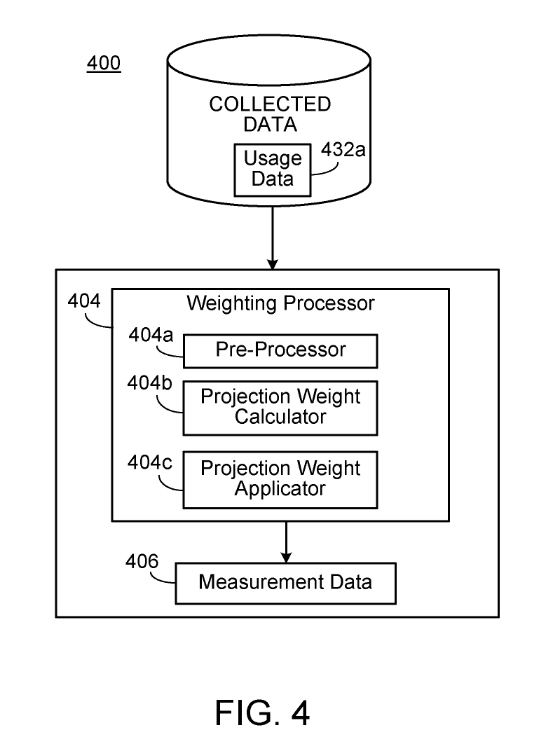

FIG. 4 illustrates an example of a reporting server 400 that, for example, may be used to implement the reporting server 240. The reporting server 400 may be implemented using, for example, a general-purpose computer capable of responding to and executing instructions in a defined manner, a personal computer, a special-purpose computer, a workstation, a server, or a mobile device. The reporting server 400 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the reporting server 400.

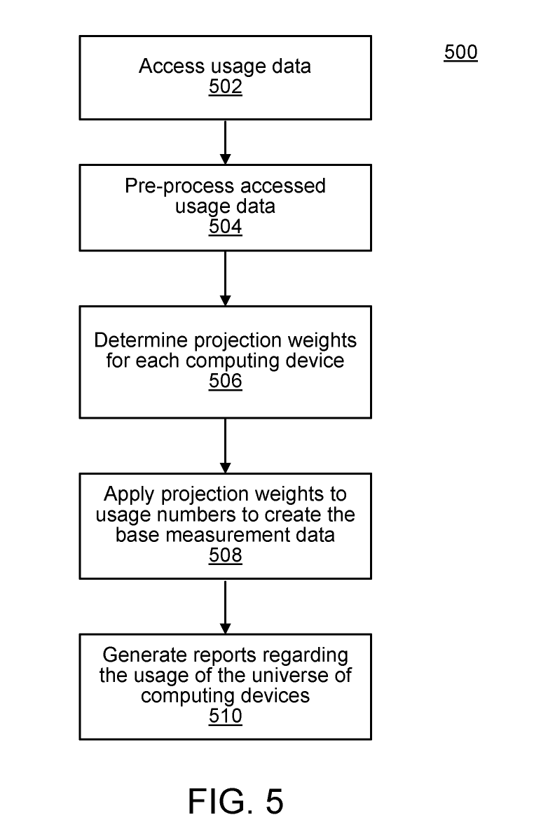

The reporting server 400 executes instructions that implement a weighting processor 404, which includes a pre-processing module 404a, a projection weight calculator 404b, and a projection weight applicator 404c. The weighting processor 404 may implement a process, such as that shown in FIG. 5, that accesses usage data 432a, for instance, from the data warehouse 230c, determines the projection weights, and applies those projection weights appropriately to obtain measurement data 406 that can be used to generate usage reports.

FIG. 5 is a flow chart illustrating an example of a process 500 that may be performed to generate usage reports. Process 500 is directed to generating usage reports that reflect resource accesses (e.g., web page visits) by the universe of all computing devices 216 (e.g., assuming a single user per device), but other types of reports can be generated using similar techniques. The following describes process 400 as being performed by the pre-processing module 404a, the projection weight calculator 404b, and the projection weight applicator 404c. However, the process 500 may be performed by other systems or system configurations.

The pre-processing module 404a accesses the usage data 432a, for example, from data warehouse 230c (502). The usage data 432a is collected based on stored state information for computing devices 216 using, for example, the process 300. As a result, the usage data 432a indicates resources accessed by the users in the panel using computing devices like computing device 216.

The pre-processing module 304a performs one or more pre-processing functions on the accessed usage data 432a (504). For example, the pre-processing module 404a may process the raw usage data 432a to form state data that represents the complete fact of usage in a single record. For instance, for web page visitation, a record in the state data may indicate that a particular computing device, on a particular date, at a particular time, accessed web page B (as represented by the URL for that web page). The pre-processing module 404a also may match some or all of the URLs in the records of the state data to patterns in a dictionary of the Internet, which may organize various different URLs into digital media properties, reflecting how the Internet companies operate their businesses. Each pattern may be associated with a web entity, which may be a web page or collection of web pages that are logically grouped together in a manner that reflects how Internet companies operate their business. For example, the various web pages that are included in the finance.yahoo.com domain may be logically grouped together into a single web entity (e.g., Yahoo Finance). The pre-processing module 404a may associate a given state record with the web entity associated with the pattern matching the URL in the state record.

The pre-processing module 404a may also remove from the usage data 432a records for computing devices that are not to be included in the reporting sample. For example, there may be rules that are evaluated to insure that a complete record of a computing devices usage and non-usage during the reporting period is received. If those rules are not met, the computing device may be removed from the reporting sample. Also, a computing device may be removed if it does not meet certain criteria, such as being in a particular geographic area.

The projection weight calculator 304b determines projection weights for each computing device in the reporting sample (406). For instance, the projection weight calculator 404b may calculate the projection weights for each computing device so that a given computing device represents a certain number of users in the universe having similar attributes as the user of the computing device, subject to the constraints that that the weights be distributed like all computing device users across genders, age groups, connection types, and values of other variables that may be used to stratify samples and that all of the weights are positive.

The projection weight applicator 404c applies the projection weight for each computing device in the reporting sample to the usage numbers for that computing device to create the base measurement data 406 (508). For example, for visitation data, the projection weight for each computing device is multiplied against that computing device's number of visits to each web entity visited by the computing device during the reporting period (e.g., as reflected by the state data) to project that computing device's number of visits to each web entity to the universe of all computing devices.

The reporting server 402 can then generate reports regarding the usage of the universe of all computing devices based on the measurement data (510). For example, to determine the total number of page views by the universe of all computing devices for a particular web entity, the reporting server 402 can add up the projected number of visits of each computing device that visited the web entity during the reporting period. The usage reports also may be generated based on specific demographics, such as age or sex. For instance, to determine the total number of page views for a particular web entity attributable to males between the ages of 18-35, the reporting server 402 may identify the panelists that meet the demographic characteristics (based on the information obtained when the panelist was recruited) and visited the web entity, and then add up the projected number of visits of each of the computing devices of those identified panelists during the reporting period. Other reports may additionally or alternatively be generated. For instance, the number of unique visits by the computing devices to certain web pages or groups of web pages. Furthermore, the process 500 may be employed to generate some or all of the various other reports described above or below.

A process similar to process 500 may be used to generate reports regarding the usage of host computing systems based, for example, on data sent by the monitoring application 212b to the collection servers 230a, 230b. For instance, web page accesses may be projected to the universe of all host computing system users, and reports may be generated regarding the web page accesses. Such reports may be employed to generate comparison reports between how users use the computing devices versus how the users use the host computing systems. For instance, this data may be used to generate some or all of the various comparative-type of reports described above or below.

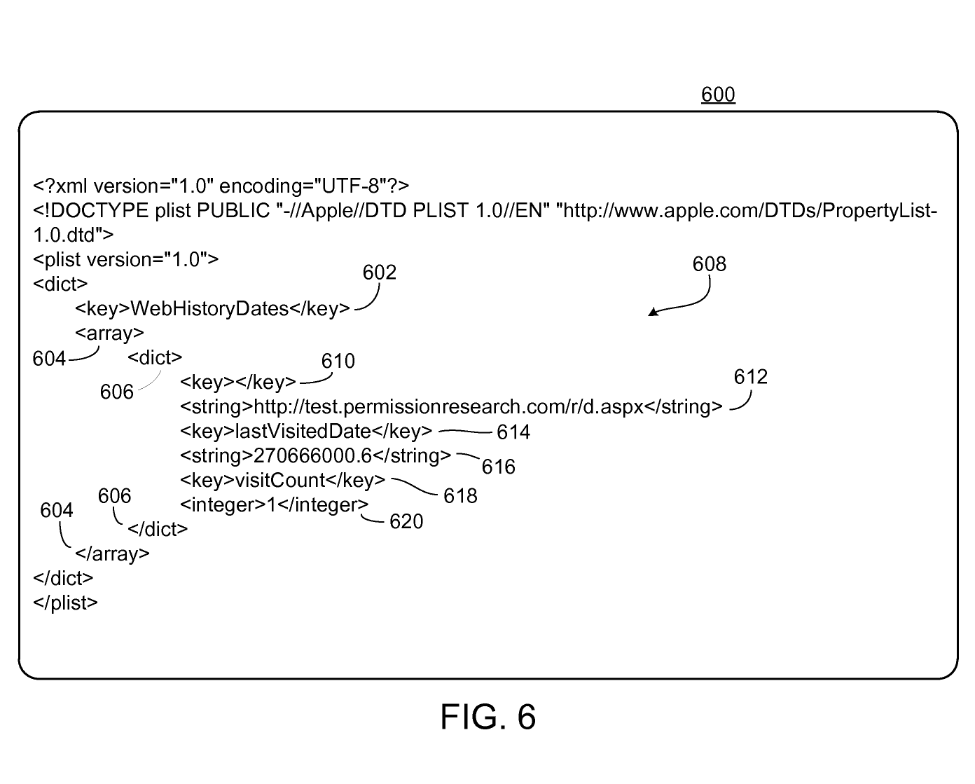

FIG. 6 illustrates an example of a state information file 600 stored, for example, on the host computing system 212. The file is an XML-based plist file containing the browsing history of web pages accessed using a browser, for example, on the computing device 216. In general, the file 600 is arranged as a set of key-value pairs. The <key> tags surrounding “WebHistoryDates” indicates that the following data is web history data, and the <array> tags indicate that the web history is stored as an array. Each entry in the array is surrounded by a <dict> tags 606. The file 600 includes one entry 608 for the browser history. In that entry, the initial <key> tags indicate that the following item represents the accessed URL. The next item is the accessed URL surrounded by <string> tags 612, which indicate the URL is in a string format. The next set of <key> tags 614 surround the phrase “lastVisitedDate,” which indicates the next item is the date that the URL was last visited. This is followed by the last date the URL was visited surrounded by <string> tags 616. The next set of <key> tags 618 surround the phrase “visitCount,” which indicates the next item is the number of times the URL has been visited. This is followed by the number of times the URL has been visited surrounded by <integer> tags 620, which designate that this value is an integer.

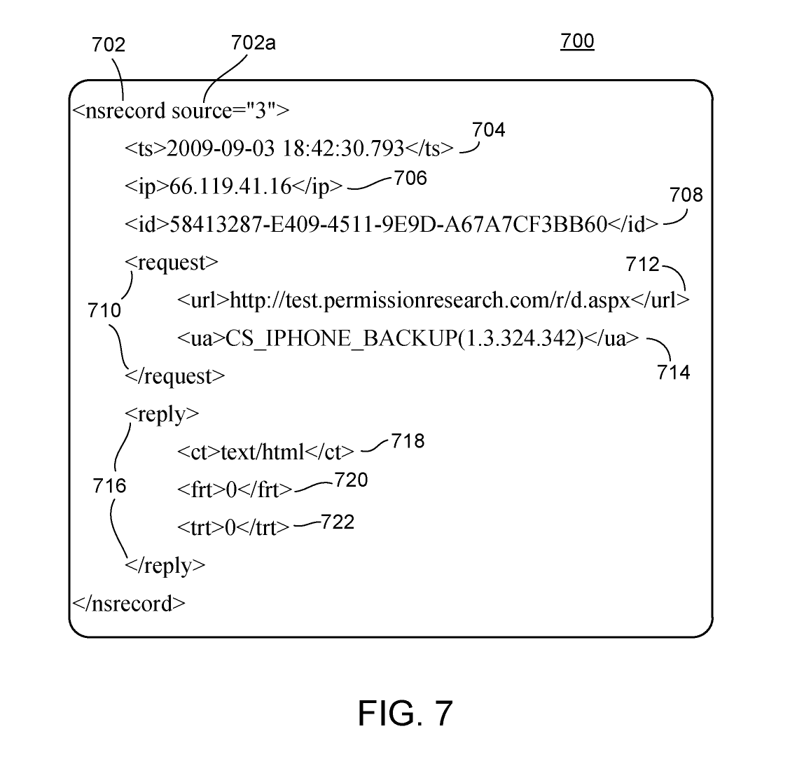

FIG. 7 illustrates an excerpt 700 of an example of an XML file that contains information about HTTP traffic collected, for example, by monitoring application 212b in response to a simulation of a request for the URL contained in the state information file 600. The XML file may be transmitted from the monitoring application 212b to the traffic collection server 230b.

The excerpt 700 includes a <nsrecord> tag 702, which includes an source attribute 702a. The source attribute 702a designates the number 3, which indicates that the request was originated based on state information and therefore represents an access of the URL by the computing device 216. The source attribute 702a designates a different number when the request originated based on a request by the browser application 212a on the host computing system 212.

The excerpt also includes a <ts> tag 704 that designates the time that this XML file was submitted to the collection server, an <ip> tag 706 that designates the external Internet Protocol (IP) address of the host computing system, and an <id> tag 708 that designates an id number that identifies the host computing system 212.

The excerpt 700 also includes a <request> tag 710 that encloses information about the request. Within the <request> tag 710 are a <url> tag 712 and a <ua> tag 714. The <url> tag 712 designates the URL that was accessed. The <ua> tag 714 designates the user agent that requested the URL. In this case, the user agent corresponds to the part of the monitoring application 212b that simulated the request. If the request was made by the browser application 212a, the user agent includes a different value that corresponds to the browser application 212a.

The excerpt 700 also includes a <reply> tag 716 that encloses information about the reply that was received in response to the simulated request. Within the <reply> tag are a <<ct>> tag 718, a <frt> tag 720, and a <trt> tag 722. The <ct> tag 718 indicates the content type (e.g., text/html, or image/png). The <frt> tag 720 designates the first byte response time and indicates the responsiveness of the web server to the request. The <trt> tag 722 designates the total time to satisfy the request. While not shown in the example 700, other tags may designate information such as HTTP response codes and data returned.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components.

Accordingly, other implementations are within the scope of the following claims.

What is claimed is:

1. A host computing system comprising:
one or more processing devices; and
a storage medium storing instructions that, when executed by the one or more processing devices, cause the one or more processing devices to implement the following:
a state storage application configured to:
retrieve, from a computing device coupled to the host computing system, state information for the computing device, the state information reflecting a current or past state of the computing device; and
store the retrieved state information in the storage medium; and
a monitoring application configured to:
access the stored state information;
send at least a portion of the accessed state information to one or more servers.

2. The system of claim 1 wherein, to send at least a portion of the accessed state information to the one or more servers, the monitoring application is configured to:
extract usage information from the accessed state information, the extracted usage information reflecting information about a user's usage of the computing device; and
send the extracted usage information to the one or more servers.

3. The system of claim 2 wherein the state information is stored as multiple files and, to extract usage information from the accessed state information, the monitoring application is configured to:
select a subset of the multiple files; and
send the selected subset of files to the one or more servers.

4. The system of claim 3 wherein, to select a subset of the multiple files, the monitoring application is configured to select the subset of the multiple files based on rules designating the subset of the multiple files.

5. The system of claim 2 wherein the usage information includes identifiers of web pages accessed by the computing device over a network and, to send the extracted usage information to the server, the monitoring application simulates a request for the web pages, records information regarding the request and subsequent response, and sends the recorded information to the one or more servers.

6. The system of claim 1 wherein the instructions, when executed by the one or more processing devices, cause the one or more processing devices to implement the following:
a browser application configured to send requests for resources and receive responses to the sent requests; and
wherein the monitoring application is configured to record information regarding the requests sent by the browser and subsequent responses, and sends the recorded information regarding the requests sent by the browser and subsequent responses to the server.

7. The system of claim 1 wherein the one or more servers are configured to generate reports reflecting usage of the host computing system or usage of the computing device based on the information sent to the one or more servers.

8. The system of claim 7 wherein the reports relate to one or more of the following: the number of unique visitors visiting certain web pages or groups of web pages using computing devices, unique visitors within a particular demographic visiting certain web pages or groups of web pages using computing devices; the amount of times a particular application or program is used on computing devices, the amount of responses to SMS or MMS advertising messages sent to computing devices, the number of applications installed on computing devices, the installation rate of a given application or of applications in aggregate on computing devices, the most popular applications on computing devices, installation locations for applications on computing devices, comparisons of various types of usage of computing devices, website visitation rates between host computing systems and computing devices; related activities across the computing devices and host computing systems; a comparison of consumption of a particular service across host computing systems and computing devices; a comparison of web search usage on computing devices versus web search usage on host computing systems, or a comparison of the amount of data accessed on host computing systems versus the amount of data accessed on computing devices.

9. The system of claim 1 wherein the host computing system is a desktop computer and the computing device is a mobile device.

10. The system of claim 1 wherein the state information is a backup of the computing device.

11. The system of claim 1 wherein the state information includes settings and user preferences related to the computing device, data for one or more applications that run on the computing device, or records of one or more actions performed by the computing device.

12. The system of claim 1 wherein the state information includes information about resources accessed by the computing device over a network, phone calls made using the computing device SMS messages sent by the computing device, applications running on the computing device, settings of the computing device, networks to which the computing device has been connected, search queries submitted for web pages, Bluetooth devices that have been paired with the computing device, WiFi networks to which the computing device has been connected, the amount of and destination of messages, applications installed, applications purchased, Global Positioning System (GPS) coordinates reflecting locations of the computing device, location information for weather services, addresses for location-based services, layout of buttons on a graphical user interface (GUI) of the computing device, applications allowed to use GPS coordinates, e-mail settings, calendar settings, preferred WiFi networks, whether WiFi or Bluetooth is enabled, contact lists, time zone preferences, stocks to be tracked, speed dial list, volume settings, or other various system and application settings.

13. A system comprising:
one or more computing devices configured to send state information to a host computing system, the state information reflecting a current or past state of the computing device;
one or more host computing systems configured to:
receive the state information from the one or more computing devices;
store the received state information;
send at least a portion of the stored state information to one or more servers;
one or more servers configured to receive at least a portion of the stored state information from the one or more host computing systems and generate one or more reports reflecting usage of the one or more computing devices based on the received state information.

14. The system of claim 13 wherein, to send at least a portion of the stored state information to the one or more servers, the one or more host computing systems are configured to:
access the stored state information;
extract usage information from the accessed state information, the extracted usage information reflecting information about a user's usage of the one or more computing devices; and
send the extracted usage information to the one or more servers.

15. The system of claim 14 wherein the state information is stored as multiple files and, to extract usage information from the accessed state information, the one or more host computing systems are configured to:
select a subset of the multiple files; and
send the selected subset of files to the one or more servers.

16. The system of claim 15 wherein, to select a subset of the multiple files, the one or more host computing systems are configured to select the subset of the multiple files based on rules designating the subset of the multiple files.

17. The system of claim 13 wherein the one or more host computing systems are configured to:
implement a browser application that is configured to send requests for resources and receive responses to the sent requests;
record information regarding the requests sent by the browser and subsequent responses; and
send the recorded information regarding the requests sent by the browser and subsequent responses to the server.

18. The system of claim 13 wherein the reports relate to one or more of the following: the number of unique visitors visiting certain web pages or groups of web pages using computing devices, unique visitors within a particular demographic visiting certain web pages or groups of web pages using computing devices; the amount of times a particular application or program is used on computing devices, the amount of responses to SMS or MMS advertising messages sent to computing devices, the number of applications installed on computing devices, the installation rate of a given application or of applications in aggregate on computing devices, the most popular applications on computing devices, installation locations for applications on computing devices, comparisons of various types of usage of computing devices, website visitation rates between host computing systems and computing devices; related activities across the computing devices and host computing systems; a comparison of consumption of a particular service across host computing systems and computing devices; a comparison of web search usage on computing devices versus web search usage on host computing systems, or a comparison of the amount of data accessed on host computing systems versus the amount of data accessed on computing devices.

19. A method comprising:
retrieving, from a computing device coupled to a host computing system, state information for the computing device, the state information reflecting a current or past state of the computing device;
storing the retrieved state information on the host computing system;
accessing the stored state information; and
sending at least a portion of the accessed state information to one or more servers.

20. The method of claim 19 wherein sending at least a portion of the accessed state information to the one or more servers includes:
extracting usage information from the accessed state information, the extracted usage information reflecting information about a user's usage of the computing device; and
sending the extracted usage information to the one or more servers.

21. The method of claim 20 wherein the state information is stored as multiple files and extracting usage information from the accessed state information includes:
selecting a subset of the multiple files; and
sending the selected subset of files to the one or more servers.

22. The method of claim 21 wherein selecting a subset of the multiple files includes selecting the subset of the multiple files based on rules designating the subset of the multiple files.

23. The method of claim 20 wherein the usage information includes identifiers of web pages accessed by the computing device over a network, and, sending the extracted usage information to the server includes simulating a request for the web pages, records information regarding the request and subsequent response, and sending the recorded information to the one or more servers.

24. The method of claim 19 wherein a browser application is configured on the host computing device to send requests for resources and receive responses to the sent requests, the method further comprising:
recording information regarding the requests sent by the browser and subsequent responses, and
sending the recorded information regarding the requests sent by the browser and subsequent responses to the server.

25. The method of claim 19 further comprising generating reports reflecting usage of the host computing system or usage of the computing device based on the information sent to the one or more servers.
